(19) United States
(12) Patent Application Publication
(10) Pub. No.: US 2025/0131365 A1
(43) Pub. Date: Apr. 24, 2025

(54) SYSTEM AND METHOD OF AUTHENTICATING CANDIDATES FOR JOB POSITIONS

(71) Applicants: Komal DANGI, Edison, NJ (US); Manvay DANGI, Edison, NJ (US)

(72) Inventors: Komal DANGI, Edison, NJ (US); Manvay DANGI, Edison, NJ (US)

(21) Appl. No.: 19/000,305

(22) Filed: Dec. 23, 2024

Related U.S. Application Data
(63) Continuation-in-part of application No. 17/166,740, filed on Feb. 3, 2021, now abandoned.
Application No. 17/166,740 is a continuation-in-part of application No. 15/806,608, filed on Nov. 8, 2017, now abandoned.

(51) Int. Cl. G06Q 10/0639; G06F 21/32; G06Q 10/1053

(52) U.S. Cl. CPC G06Q 10/06393; G06F 21/32; G06Q 10/1053

(57) ABSTRACT

A talent management system includes creating a data set associated with a plurality of positions and training a large language model using the data set, receiving a request associated with an open position from one or more candidates, interviewing a candidate selected from the one or more candidates using an adaptive questionnaire, wherein the adaptive questionnaire dynamically adjusts a next question based on a previous response to a previous question, evaluating a candidate based on real-time benchmarking of the candidate, wherein the real-time benchmarking compares the candidate's performance to one or more position metrics using neural network algorithms, stack-ranking the candidate compared to other candidates, and generating a report based on the stack-ranking step

### CROSS REFERENCE TO RELATED APPLICATIONS

This application is a continuation-in-part of pending U.S. patent application Ser. No. 17/166,740, filed Feb. 3, 2021, which is a continuation-in-part of U.S. patent application Ser. No. 15/806,608 filed on Nov. 8, 2017, now abandoned, the contents of which are incorporated herein by reference in its entirety.

### BACKGROUND

The present disclosure relates to verification of candidates for job positions using voice and face biometrics.

Recruitment is a core function of human resource management. It is the first step of appointment. Recruitment refers to the overall process of attracting, selecting and appointing suitable candidates for jobs (either permanent or temporary) within an organization. Managers, human resource generalists and recruitment specialists may be tasked with carrying out recruitment, but in some cases public-sector employment agencies, commercial recruitment agencies, or specialist search consultancies are used to undertake parts of the process. Internet-based technologies to support all aspects of recruitment have become widespread.

The human resource industry is currently facing challenges regarding the authenticity of candidates for job positions. For example, candidates may falsify their resumes and/or have proxy interviews, in which individuals other than the candidate perform the interview.

As can be seen, there is a need for a system and method of authenticating candidates for job positions.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

In one aspect of the present disclosure, a system of verifying a candidate comprises a database hosting a web server, wherein the web server comprises: a search portal for a first client to search the database for candidate profiles based on entered search criteria; a list portal for consolidating selected candidate profiles from the search, initiating the first client to call each of the selected candidates for a first interview, recording the first interview and saving a recorded first interview to the database, initiating the first client to call each of the selected candidates for a second interview, recording the second interview and saving a recording of the second interview to the database; and a voice verification module to determine if a voice from the recording of the first interview matches a voice from the recording of the second interview.

In another aspect of the present disclosure, a computer implemented method of verifying a candidate comprises the steps of: searching, by a first client, a database for candidate profiles by entering search criteria on a web server wherein a plurality of results of the candidate profiles are displayed; selecting, by the first client, at least one of the candidate profiles within the plurality of results; calling, by the first client, a candidate of the candidate profile, wherein the web server automatically records a first interview and saves a first interview recording on a web server database; calling, by the first client, the candidate of the candidate profile, wherein the web server automatically records a second interview and saves a second interview recording on the web server database; comparing a first interview recording with the second interview recording using voice recognition software to determine if a voice from the first interview recording matches a voice from the second interview recording.

These and other features, aspects and advantages of the present disclosure will become better understood with reference to the following drawings, description and claims.

### BRIEF DESCRIPTION OF THE DRAWINGS

FIG. 1a is a schematic view of an embodiment of the present disclosure;

FIG. 1b is an exemplary functional block diagram of a total talent management system in accordance with the present disclosure

FIG. 1c is an exemplary functional block diagram of an exemplary architecture of a total talent management system.

FIG. 1d is an exemplary architecture showing various application programming interfaces between a management system and external servers.

FIG. 1e is an exemplary diagram illustrating the building of a candidate skills model.

FIG. 2 is a flow chart of an exemplary method of the present disclosure;

FIG. 3 is a continuation of the flow chart of FIG. 2;

FIG. 4 is a block diagram of an embodiment of the present disclosure; and

FIG. 5 is a continuation of the block diagram of FIG. 4.

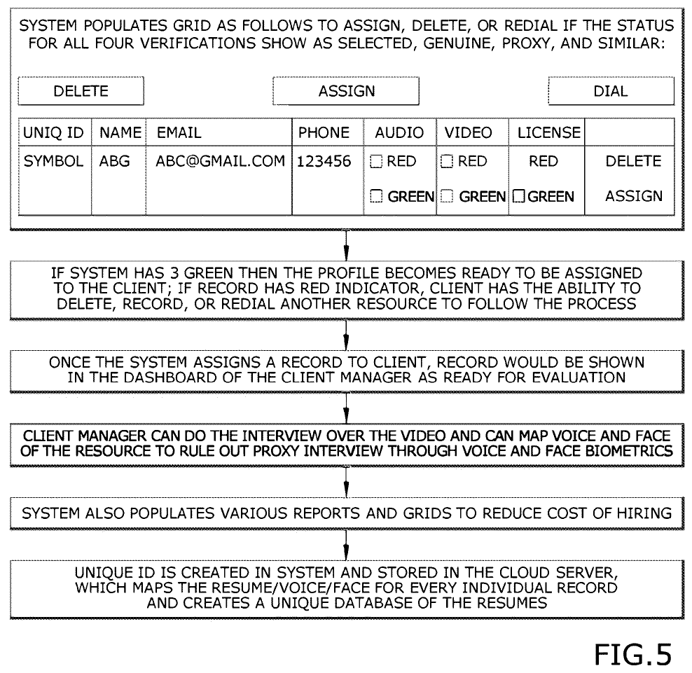

FIG. 6 is an exemplary flow diagram of an alternative embodiment of the system and method of the present disclosure.

### DETAILED DESCRIPTION OF ILLUSTRATIVE EMBODIMENTS

System Overview. The present disclosure is directed to an end-to-end talent management system, which includes artificial intelligent engines, data base management tools and biometric and other forms of personal identification, verification and authentication methods. As such, the disclosure provides a practical application that solves a persistent problem in the recruitment functions for companies. Specifically, the present disclosure provides for the efficient identification of qualified candidates, proactively manage the recruitment process, and verify the identity and resume of the candidates from end-to-end. The total talent management system provides interview-ready candidates to hiring managers.

The present disclosure includes a system and method of authenticating candidates using voice mapping, bio metrics and multi call functions. The voice verification for interviews includes mapped audio inputs from multiple interviews. The identification card verification may be verified by a third party. The experience verification includes a system that calculates expected actual experience by identifying the age of the candidate and comparing the age with the experience listed on the resume. The present disclosure may further include a predictive dialer for recruiters to cut down their time on dialing resources to find their availability.

The disclosure also includes an advanced AI-powered assessment platform leveraging a cutting-edge large language model (LLM) trained on hundreds of thousands of hours of structured and unstructured interview data. The system incorporates adaptive testing algorithms that utilize reinforcement learning to dynamically adjust question difficulty based on real-time performance metrics, ensuring precise skill benchmarking. Proctoring is enhanced through AI-driven computer vision and natural language processing (NLP) models to monitor candidate behavior, detect anomalies, and prevent fraudulent activities.

The stack-ranking mechanism may employ weighted scoring matrices and neural network-based evaluations to generate granular, multi-dimensional performance insights. In an embodiment, the platform integrates with cloud-based architectures for scalable deployment and supports multilingual assessment pipelines via fine-tuned transformer models. A robust API layer facilitates seamless integration with third-party HR and educational systems. Additional features may include advanced data encryption for compliance with stringent privacy standards and regulations, including but not limited to GDPR and CCPA. Real-time dashboards may be provided which, in an embodiment, may be powered by predictive analytics for strategic decision-making. The disclosure is optimized for large-scale use in talent acquisition, professional certification, and workforce development domains.

The present disclosure permits the formation and execution of smart hiring campaigns. There may be a direct sourcing engine by which select job openings are proactively distributed to agencies and individuals using mapping tools and supported by voice sample collections and technical assessments of potential candidates. The smart hiring campaigns may include smart dialer technology for calling and text messaging using SMS or MMS messaging. An analytics engine may be used to populate data relating to recruiting resources and identify resumes using artificial intelligence/machine learning tools and with the help of AI/ML and GIS implementation. Moreover, reports may be generated using predictive analytics.

The present disclosure may leverage big data analytics and AI/ML algorithms to provide an end-to-end total talent management acquisition that combines all aspects of the search, interview and fulfillment processes with all relevant data accessible from one central hub.

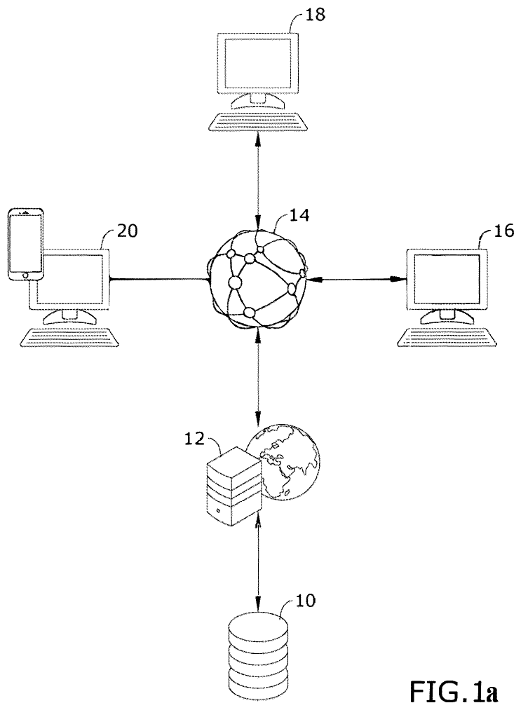

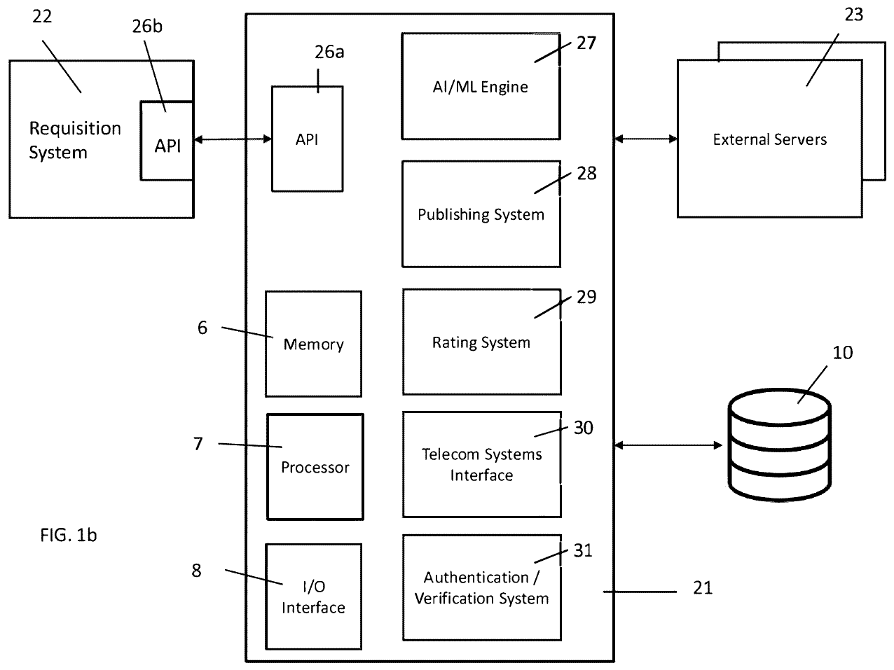

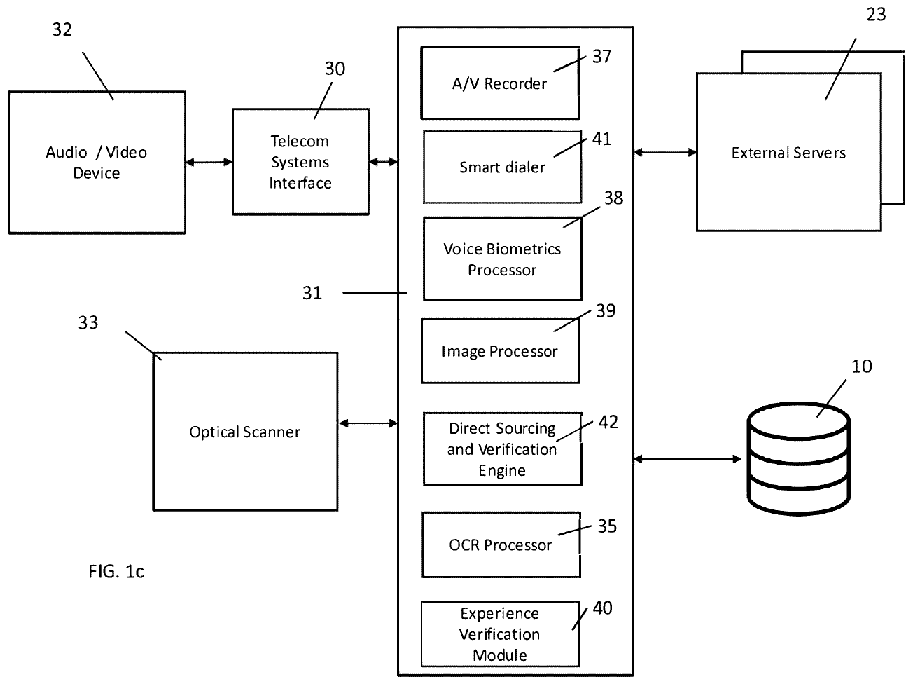

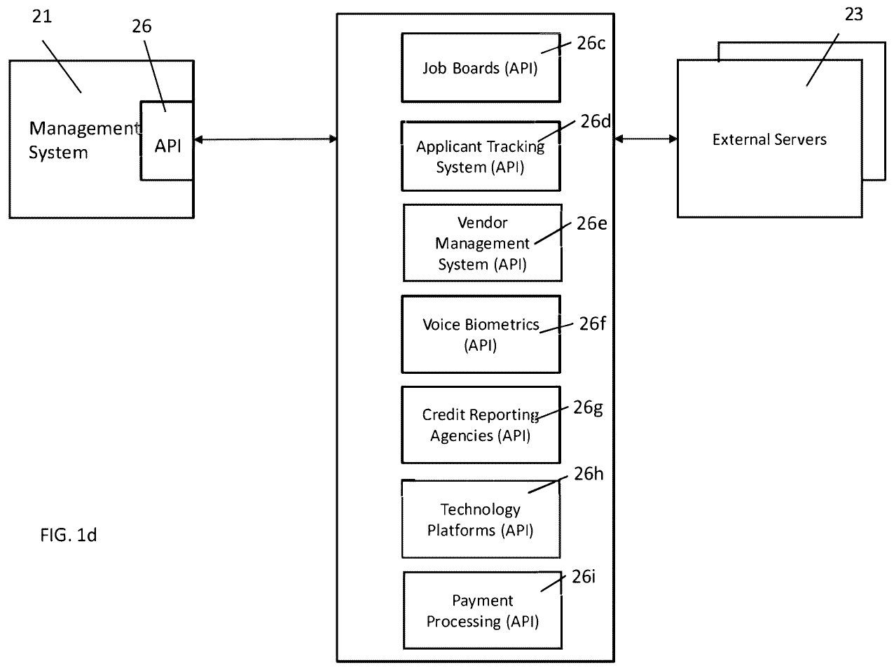

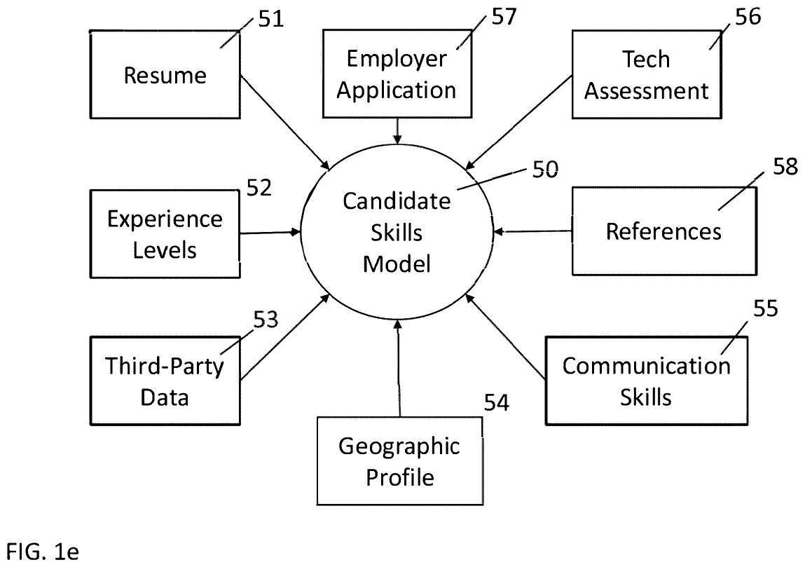

System Operating Environment. Referring to FIG. 1, the system and method includes a database 10 and a web server 12 having access to the database 10. Multiple clients 16, 18 may access the web server 12 over a communications network 14, such as a telecommunications network, the Internet and the like. The clients 16, 18 may use the web server 12 to conduct interviews of the candidates 20, record and save the interviews to the database 10, and verify the identity of the candidates by comparing the recorded interviews.

System Architecture. With reference to FIG. 1b, there is shown an exemplary functional block diagram of the total talent management system 21 which may, for example, comprise one or more web servers 12 and be a combination of hardware and software modules which provide the functionality. It shall be noted that this is exemplary only and that not all components are needed and there may be other components not shown or described herein. It shall also be understood that not all interconnection lines between functions and subfunctions within the management system 21 are shown, indicating that it is possible that any function or subfunction may communicate with any other function or subfunction.

The management system 21 may communicate with an external requisition system 22 through APIs 26a, 26b. The requisition system 22 may be operated by a third party seeking to hire qualified candidates, a recruiter looking to match qualified candidates to specific positions, or by an internal operator of the management system 21. While shown as an external requisition system 22, the requisition system 21 may also form part of the management system. The requisition system 27 may provide a user interface that permits the hiring party to manage the talent acquisition process from start to finish, including accessing the results of the pre-screening of candidates from the publishing system 28. The requisition system 22 may receive as inputs HR hiring campaigns, vertical hiring openings and direct sourcing of candidates. Such inputs may, for example, include one or more job postings or descriptions for one or more employers.

The management system 21 may also be in communication with one or more external servers 23. Such external servers 23 may, for example, be operated by third-party vendors that accumulate and curate resumes or job listings. The management system 21 may also be in communication with one or more internal or external databases 10.

With the management system 21, there is shown an artificial intelligence/machine learning (AI/ML) engine 27. For the purposes of this disclosure, unless otherwise specified, artificial intelligence and machine learning will be used interchangeably and referred to generally by the designation AI/ML. The AI/ML engine 27 may serve multiple functions as set forth herein. For example, external servers 37 may be connected to job message boards or third-party databases of resumes. The AI/ML engine 27 may use its algorithms to match resumes from the external servers 37 to postings from the requisition system 22. By way of example, the AI/ML engine 27 may associate experience listed on resumes to qualifications of successful employees at the firm. Likewise, the AI/ML engine 27 may associate an applicant to a pool of applicants that have previously applied for the sought-after position. The AI/ML engine 27 may collect data in a database relating to the reference pool and continue to refine its association algorithms. To do so, AI/ML engine 27 may use linear regression analysis or multiple regression analysis to predict the best matches of resumes to positions. It will be understood that the foregoing algorithms are exemplary only and one or more other AI/ML algorithms may be used.

The AI/ML engine 27 may also work in conjunction with the authentication or verification system 31. As an initial matter, the AI/ML engine 27 may score the resume and discount those with misspelled words or grammatical errors. Moreover, as set forth above, the AI/ML engine 27 may cull the candidate resume information to provide the top “x” number of matches. Thereafter, the AI/ML powered verification system assists in the review of candidate information, screens and background checks candidates and assists in the shortlisting of qualified talent. The AI/ML engine 27 allows scaling of the system which otherwise cannot be achieved.

The authentication system 31 may use voice recognition and voice mapping software to confirm the identity of a candidate during an interview as described in more detail below. The authentication system 31 may also use facial recognition software to verify the candidate on a video interview matches the uploaded photograph from a driver's license or other official document such as a government-issued passport in a process described in more detail below. The authentication system 31 may also use the birthdate information from the driver's license and/or other official document to gauge whether the candidate's age matches the level of experience listed on the resume.

The management system 31 may have a telecommunications system interface 30 that interacts with an audio/video telecommunications system (not shown) to schedule audio/video calls for interviews. The telecommunications system interface 30 may also interact with the verification system 31 as described in more detail with reference to FIG. 1c.

The verification system 31 may receive content from an audio/video device 32 through telecommunications systems interface 30. The verification system 31 may have a recorder 37 configured to record interviews and other audio and/or video communications with a candidate. Those videos may be stored and later used by the voice biometrics processor 38 and image processor 39 to verify the identity of the candidate by matching a first voice recording to a second voice recording and matching the image to the stored image obtained from an identification card as set forth below. Unless otherwise specified herein, use of the term voice biometrics processor 38 is synonymous with the term voice verification module.

The functionality of the voice biometrics processor 38 may, for example, be known in the art. In an aspect, the voice biometrics processor may digitize a profile of a person's speech to produce a stored voice print similar to storage of a person's fingerprint. The technology reduces each spoken word to segments having tones comprised of several dominant frequencies which can be compared to other voice samples to determine if the voice sample is from the same or a different person. Applying this known technique, voice biometrics can be used to discriminate between speakers.

Likewise, the image processor 39 is able to use known techniques in the art to discriminate between two different individuals and to verify that the video of a candidate during the interview matches the photograph of the candidate on the identification card.

The verification system 31 may interface with an optical scanner 33 and use an optical character recognition processor 35 or the equivalent in order to receive and extract information from an identification card such as a driver's license or other official document. Such functionality will provide the verification system candidate information including, for example, birthdate (to calculate age), a photograph, address and other information which may be used to verify the authenticity of the resume or the identity of the candidate during subsequent interviews.

The management system 21 may have a rating system 29 that creates a score for each candidate based on one or more factors, including, for example, the similarities of the candidate's resume to the job description, an evaluation of the candidate by an interviewer, the verification of the identity of the candidate by the verification system 31, and other factors relevant to the hiring decision.

The management system 21 may have a publishing system 28 which provides an output to internal or external users of the management system 21. Such output may include the top candidates and their respective evaluation scores, the resumes of the top candidates, a recommendation for next steps, an identity certification for the top candidates, a summary of the search process, fees associated with the search process and the external resume databases, if any, and other information that may be relevant to the user.

The management system 21 may provide other automated or semi-automated functions in addition to those described above. For example, the management system 31 may include candidate reference checking. The management system 21 may include technical screening of candidates, which may, for example, include administering online aptitude or competency testing. The management system 21 may be accessible from a desktop computer or a mobile application.

The management system 21 may have a memory 6, processor 7 and an input/output interface 8. In an aspect, the processor 7 may be coupled to the input-output interface 8 and further coupled to a memory 6. The memory 6 may have stored thereon executable instructions that when executed by the processor 7 cause the processor 7 to effectuate operations that perform the various exemplary methods of use set forth herein and in the appended claims.

Application Programming Interfaces. FIG. 1b shows an application programming interface between API 26a and API 26b between the management system 21 and the requisition system 22. This provides access for businesses, professional recruiting firms, and other third parties to create an access point to the management system by which job openings or recruiting initiatives may post job requisitions utilize the functionality of the management system 21.

While only one exemplary API is shown in FIG. 1b, additional APIs may be included, examples of which are shown in FIG. 1d. Shown is the management system 21 and associated example of a generic API 26 integral with or in communication with the management system 21. There is also shown various APIs 26c through 26i, in communication with API 26, it being understood that API 26 may be adapted to interface with any of the various APIs 26c through 26i or there may be multiple APIs 26 which are customized to interface with APIs 26c through 26i. Also shown is the external servers 23 which may support functionality supported by management system 21 and accessed through API 26 and one or more APIs 26c through 26i. It should be understood that this list of APIs and the system configuration of FIG. 1d is exemplary only and there may be additional or less APIs in any given system and there may be different system configurations than that shown.

Continuing with the description of FIG. 1d, there may be an API to one or more job boards wherein operators of such job boards may provide candidate resumes or profiles to meet open requisitions.

There may also be an API to one or more Applicant Tracking Systems (ATS). Many talent acquisition firms or human resource departments use ATS functionality to assist in automating talent acquisition needs to improve the overall experience of recruiters as well as candidates.

There may also be a vendor management system (VMS) API, which may, for example include SAP Field glass, Beeline, and other functions. The VMS may, for example, be a web-based, cloud application that acts as a mechanism for businesses to manage and procure staffing services, including temporary or permanent placement services, as well as outside contract or contingent labor. Typical features of a VMS may include, for example, requisition and bid management, timekeeping, consolidated billing, comprehensive reporting and automation workflows to streamline processes while minimizing risks of errors.

There may be additional APIs for voice biometrics, credit reporting agencies, data and technology programming platforms, and payment processing gateways.

The API's may also define standard data formats for ingestion into the management system 21. As such, data from disparate sources such as that from various resume sites can be used by the management system 21. Similarly, data from other third-party sources such as state Departments of Motor Vehicles (DMVs) from various states can be standardized and normalized. It will be understood that each API may translate data from any external third-party source to a format recognized by the management system 21 or such data format translation may occur prior to such data being transmitted to the API.

Candidate Skills Model. FIG le illustrates an exemplary candidate skills model 50 and various inputs which may be considered to build the candidate skills model 50. A candidate's resume 51 may be used as an initial source input to the candidate skills model 50. In certain embodiments, a potential employer or a staffing agency may have its own application or questionnaire—shown as employer application 57—to be completed by a candidate which may also serve as a source input to the candidate skills model 50. The employer application may include information typically included in a resume as well as additional information particular to the position being sought, including but not limited to general interests and hobbies, skills assessment data, candidate goals, and any other information which may be relevant to a potential employer.

Additional inputs to the candidate skills model 50 may be experience levels 52 relevant to the position being sought. Such information may be extracted from a resume, employer application, or other source. For example, a candidate may have 20 years of professional experience, but only 3 years of that experience in the relevant industry. The experience level 52 input may include one or both of such experience levels. A geographical profile input 54 may be included in the candidate skills model 50. Here, a history of the geographic locations a candidate has lived and worked may be included or a geographic preference of the candidate may be included. Such geographic data may, for example be extracted from a resume 51 or employer application 57 or as an input provided by an interviewee to an interviewer. The geographic profile 54 input may also match the geographical history or preferences of a candidate with the geographic limitations or preferences identified by an employer in the position requisition.

Geographic profile 54 inputs may also be provided as part of third party data 53 input. Third party data 53 may come from external servers and may, for example, include other public information about the candidate's geographic history. Third party data 53 may also include information from social media posts associated with a candidate, memberships in organizations, driver information, public records, and other information available from external servers 23 deemed to be relevant based on the requisition.

Often a candidate may provide references which may serve as reference input 58 to the candidate skills model 50. References may come from a former employer, a teacher, a co-worker or other persons that know the candidate well. Other reference inputs may be based on a networking contact that the candidate has within the hiring organization.

As the interview process progresses, communication skills 55 and technical assessments 56 of the candidate may be provided as inputs to the candidate skills model 50.

The candidate skills model 50 provides a holistic view of the candidate as may be relevant to the position requisition. Moreover, as the candidate skills model 50 is able to ingest additional data as it becomes available, the candidate skills model 50 for any individual candidate may be revised—positively or negatively—at any time.

Artificial Intelligence and Machine Learning. In an aspect, the direct sourcing and verification engine 42, whereby open job requisitions may be distributed to placement agencies and individual recruiters, may be powered by AI/ML algorithms. The direct sourcing engine may receive input resumes 51 from such placement agencies or individual recruiters which may trigger the development of the candidate skills model 50. Relevant information may be extracted from the resume inputs 51 through use of the analytics engine to populate data of resources and resume with the help of AI or ML algorithms and geographic inputs. AI or ML algorithms may be used to create the candidates' skills models 50. Further support may thereafter be provided by providing voice samples and candidate skills models. In an aspect, smart campaigns are supported by a telecommunications interface to facilitate calling and texting via short message systems (SMS) and multi-media systems (MMS).

The candidate skills model 50 may then be used as an input to a predictive analytics model which would identify, match and rank qualified candidates to open positions and generate reports to the campaign managers.

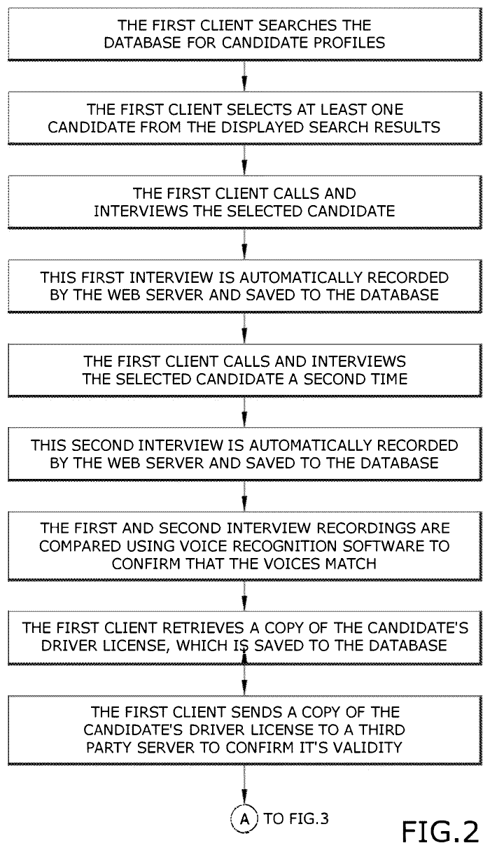

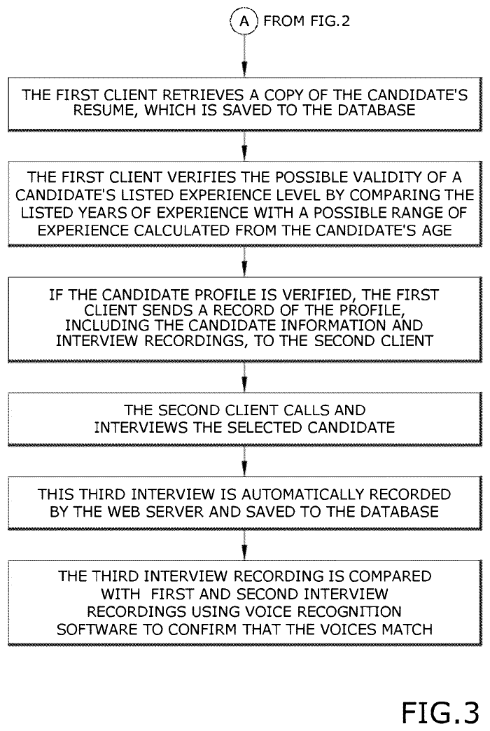

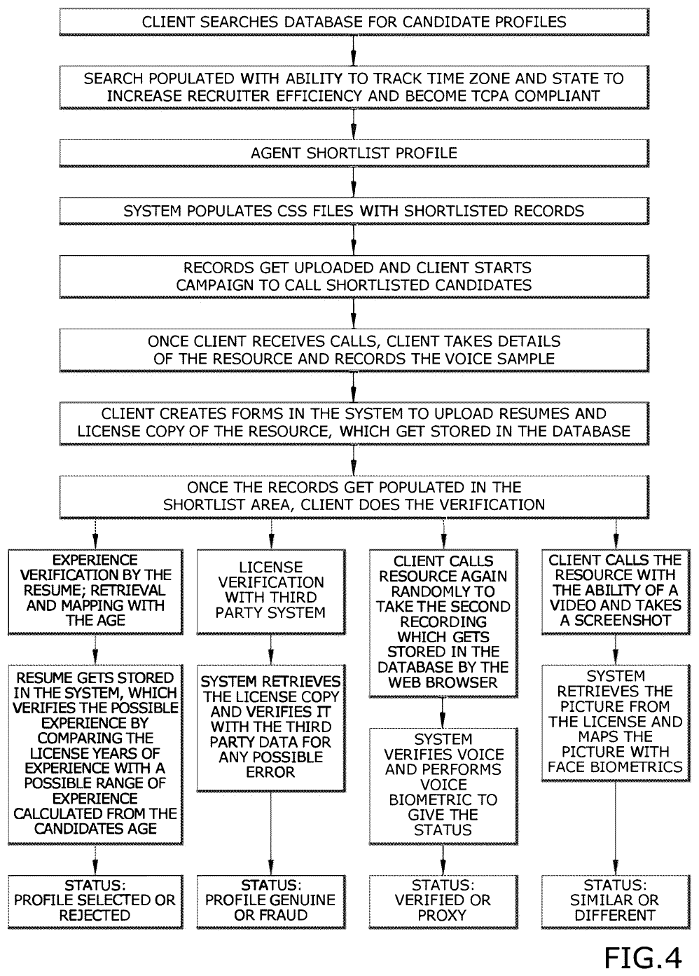

Methods of Use. The following is an exemplary method of the present disclosure with reference to FIGS. 2, 3 and 4. Clients 16, 18 may initially register to access the web server 12 by creating a username and password. The client 16, 18 may do so using a computer accessing the web server 12 over the Internet. The computer includes software, such as an Internet browser, that enables the computer to display information received from the web server 12 on a display device of the computer. The computer may include input devices such as a mouse and a keyboard that allows the client 16, 18 to input data. In certain embodiments, the computer may be a smart device with a touch screen interface, such as a smart phone or a tablet. The smart device may include a software application (app) loaded on a memory. The app allows the clients 16, 18 to sign onto the web server 12 and access the web server over the Internet.

The clients 16, 18 may include at least a first client 16 and a second client 18. The first client 16 may be a recruitment company. The recruitment company may include a recruiter and a recruiter manager. The second client 18 may be a company in search for the employee, i.e. an employer.

The first client 16 signs into the web server 12 and begins to search for potential candidates via a search portal of the web server 12. In certain embodiments, the database 10 may store a plurality of candidates' names linked to additional information, such as their geographic location and specialty skills. The web server 12 provides the search portal in which the first client 16 may perform a search of the plurality of candidates within the database 10. In alternative embodiments, the search portal may access external servers 23 associated with other job searching third party websites' databases, such as, but not limited to DICE™, MONSTER™, CAREERBUILDING™, TECHFETCH™ and the like via the Internet. The first client 10 may thereby search for a candidate using the search portal and in response thereto, the web server 12 pulls candidate profiles from the job searching websites and presents the candidate profiles to the user.

As set forth above, AI/ML engine 27 may assist with the screening and selection of candidate profiles. The AI/ML engine 27 may include an algorithm that parses resumes to extract information relevant to the position requisition. Alternatively, the AI/ML engine may access and assess parsed resume data received through an API. The AI/ML engine 27 may also access database 10 to access data that may include similar position requisitions and data associated with successful candidates that filled such similar position, such as educational background, years of experience, industry classifications and other data. The algorithm may be seeded with such data and continually learn which candidate profiles tend to be most successful. The AI/ML engine 27, after selecting such candidate profiles, may then receive additional inputs such as those described above with reference to FIG. le, to form a candidate skills model 50 for each candidate profile. The AI/ML engine 27 may then use predictive analytics models, such as forecast models, to predict which candidates will likely be most successful and to rank those candidate profiles based on a numerical score value. Other predictive analytics models may also be used, including, for example, a classification model in which the AI/ML engine 27 separates the data into categories that are applicable to previously successful candidates and then compares the data associated with the current selection of candidate profiles to the data classifications to determine whether a particular candidate is likely to be successful. Clustering models and others may also be used by the AI/ML engine 27.

Once the search has been performed, the web server 12 provides a list of candidate profiles that either match the search entered by the first client 16 or that were ranked the highest by the AI/ML engine 27. For example, the list may be in the form of cascading style sheet (CSS) files. Each of the candidate profiles may include the candidates name and a brief overview of the candidate. The web server 12 may also display the location of user as well as the time zone to increase recruiter efficiency. The first client 16 may select the candidates name and an expanded candidate profile may be generated. The expanded candidate profile may include additional details of the candidate, and may, for example, include the candidate skills model 50. The additional details may include, but not are limited to, specialty skills, years of experience, location, willingness to relocate, desired job position, hourly rate, salary request and any other data that may be pulled from the job searching websites or that is already stored on the database 10. The first client 16 may review the expanded candidate profile. If the first client 16 is interested in interviewing the candidate, the first client 16 may save the profile to a manage list portal.

The manage list portal provides a list of all of the candidate profiles which the first client 16 has saved. For example, the list may be in the form of cascading style sheet (CSS) files. When the first client 16 has saved the candidate, the web server 12 prompts the first client 16 to call the candidate 20 and retrieve additional information. The telecom systems interface 30 which may include a smart dialer 41, may be engaged to automatically schedule and call each prospective candidate to be interviewed. In such embodiments, the recruiter of the recruiting company may call the candidate 20 to retrieve additional information. The first client 16 calls the candidate 20 and retrieves the additional information, such as, but not limited to, the candidate's date of birth, address, email address, a resume to upload, and pictures of the front and back of the candidate's identification card (state driver's license/passport). The first client 16 may enter the information to the web server 12 via the manage list portal. Alternatively, the information may be scanned via an optical scanner 33 and read by the OCR processor 35. The additional information is saved to the database 10. The first interview may be automatically recorded by A/V recorder 37 and saved to the database 10.

Once the additional information has been added, the lists of the candidate profiles, including the most up-to-date candidate skills model 50, may be moved to a candidate list portal. The candidate list portal allows the first client 16 to verify the candidates voice with a voice verification using the voice biometrics processor 38, verify the candidates age with an age verification engine 42 and verify the candidate's identification card with an identification card verification module (not shown).

The manager of the recruiter may use the candidate list portal to call the candidate 20 for an interview. The manager may randomly call the candidate to ask technical questions. A second phone call is automatically recorded and saved to the database 10. The manager may select a verify voice button which prompts the web server 12 to use voice recognition software of the voice biometrics processor 38 to compare the first recorded phone call and the second recorded phone call. If the voice verification module determines that the first recorded phone call matches the voice of the second recorded phone call, the web server 12 indicates the same candidate 20 conducted both interviews. If the voice biometrics processor 38 determines that the first recorded phone call does not match the voice of the second recorded phone call, the web server 12 indicates the candidate profile is fraudulent.

The first client 16 may further verify the user's identification card and the user's experience. The manager may further select a verify identification card button which prompts the web server 12 to send the picture of the candidate's identification card to a third-party verification server. The third-party verification server 37 may communicate with the web server 12 over the communications network 14 and verify that the identification card is not fraudulent. Once the identification card has been verified, the manager may further select a verify experience button, which prompts the web server 12 to compare the age of the candidate 20 with the user's listed years of experience, which may, for example, be gleaned from the candidate's resume or employer application 57. The age of the candidate 20 may be pulled by parsing a copy of the identification card. If the listed years of experience is within a possible range of experience based on the candidates age, the web server lists the candidate profile as verified. If the listed years of experience is outside of a possible range of experience based on the candidates age, the web server lists the candidate profile as possibly fraudulent. Because the age of the candidate may be confidential and not used in evaluating candidates, the experience verification in the verification engine may only return a “positive” or “negative” result as to whether the age and experience are within an acceptable range. It may be that the years of experience listed too high for the age of the candidate prompting a negative result. Likewise, the years of experience listed may be too low for the age of the candidate (i.e., 10 years-experience for a 55-year-old) may also prompt a negative result, potentially flagging significant gaps in work experience.

If the candidate's identification card, voice and amount of experience has been verified by the web server 12, the first client 16 may then send an email and transfer the record to a second client 18 via a transfer portal. The first client 16 may do so by selecting a transfer button which prompts the first client 16 to enter the second client's 18 and identifier, such as an email address, phone number, username and the like. The first client 16 enters the second client's 18 identifier and selects a send button. The web server 12 then transfers the records of the verified candidate profile from the first client 16 to the second client 18. The second client 18 may then interview the candidate 20 and use the voice verification module. The web server 12 allows the second client 18 to dial the phone number of the candidate and automatically records and stores a third recorded phone call. The second client 18 may select a verify voice button which prompts the web server 12 to use the voice recognition software of the voice verification module to compare the third recorded phone call with the first and second recorded phone call. If the voice verification module determines that the third recorded phone call matches the voice of the first and second recorded phone call, the web server 12 may indicate the voice of the candidate 20 has been verified to the second client 18. If the voice verification module determines that the third recorded phone call does not match the voice of the first and second recorded phone call, the web server 12 may indicate the voice of the candidate 20 is fraudulent to the second client 18.

In certain embodiments, the present disclosure may include a facial recognition module to further authenticate candidates 20. For example, interviews may be conducted via video chat. In such embodiments, a first interview is conducted in which a snapshot of the client is taken, or a recorded video chat is saved to the database 10. The clients 16, 18 may select a verify facial button which prompts the web server 12 to use facial recognition software, such as face biometrics, of the facial verification module, to compare the recorded video chat or snapshot with the picture on the identification card. If the facial verification module determines that the face of the recorded video or snapshot matches the face of the picture on the identification card, the web server 12 indicates the same candidate 20 conducted both interviews. If the facial verification module determines that the recorded video chat or the snapshot does not match the picture on the identification card, the web server 12 indicates the candidate is fraudulent.

The present disclosure may further include an automatic dialer module. In such embodiments, when the first client 16 adds the candidate profiles from the search results to the manage list portal each of the candidates' names and phone numbers may be uploaded to a spreadsheet. The automatic dialer module then automatically calls each of the candidates 20 in the order on the spreadsheet. If the candidate 20 answers the phone, the automatic dialer module automatically transfers the candidate to the recruiter (first client 16). If the phone call goes to a voice mail, the automatic dialer module may leave a prerecorded voicemail for the candidate to call a phone number back.

In an alternative embodiment, the entire system and method may be automated to remove or limit the activities of a live interviewer. For example, there may be an advanced AI-powered assessment platform leveraging a cutting-edge large language model (LLM) trained on hundreds of thousands of hours of structured and unstructured interview data. The system incorporates adaptive testing algorithms that utilize reinforcement learning to dynamically adjust question difficulty based on real-time performance metrics, ensuring precise skill benchmarking. Proctoring is enhanced through AI-driven computer vision and natural language processing (NLP) models to monitor candidate behavior, detect anomalies, and prevent fraudulent activities.

There may be a stack-ranking mechanism employs weighted scoring matrices and neural network-based evaluations to generate granular, multi-dimensional performance insights. The platform integrates with cloud-based architectures for scalable deployment and supports multilingual assessment pipelines via fine-tuned transformer models. A robust API layer facilitates seamless integration with third-party HR and educational systems. Additional features include advanced data encryption for compliance with GDPR and CCPA, as well as real-time dashboards powered by predictive analytics for strategic decision-making. This solution is optimized for large-scale use in talent acquisition, professional certification, and workforce development domains

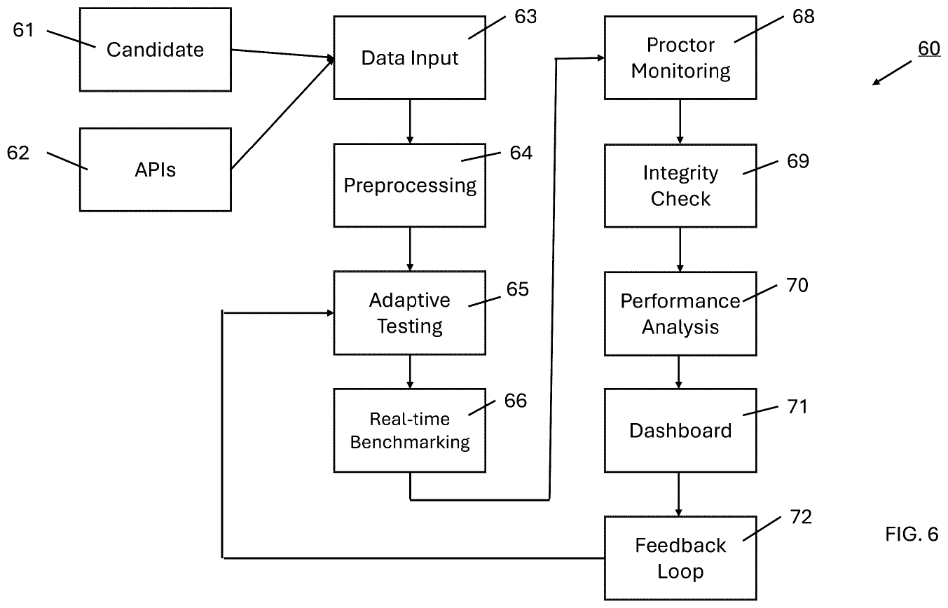

This process is further defined with reference to FIG. 6, which represents an automated workflow 60 in accordance with the present disclosure. The process 60 may start with a prospective candidate entering personal and application information 61 with respect to a particular job opening (or multiple job openings) into a system, which may, for example, be through a dedicated portal available on-line. Additionally, APIs 62 to other candidate profiles and applications may be provided. Such APIs may access candidate data from candidate databases, including, for example, educational databases from a collegiate placement office incorporating information relating to recent graduates or soon-to graduate students, third party databases, employer databases, and the like.

With respect to the candidate-originated input, such input may, for example, include text, audio, or video responses. The candidate input may include written responses to an application or questionnaire. Alternatively, the candidate input may include audio and/or video input based on queries generated by the system or from one or more live interviewers.

Regardless of the origin, the data is received as input at 63. At 64, preprocessing of the input is performed. Such preprocessing may include one or more of the following: transcription of audio input data, noise filtering of audio/video inputs, and NLP-based tokenization of the inputs. Such tokenization may be the first step in the NLP pipeline which segments unstructured data inputs and natural language text transcriptions into discrete informational elements. As such, the preprocessed data at 64 may be used for the remainder of the workflow illustrated in FIG. 6 as well as for training data for the AI/ML algorithms themselves.

At 65 adaptive testing of the preprocessed inputs is performed. Adaptive testing may include an analysis of candidate inputs and responses using the candidate inputs using LLM. Adaptive testing may include dynamically adjusting the difficulty of subsequent questions based on performance metrics associated with the candidate's answers. For example, questions may be made progressively harder as the automated interview progresses. Alternatively, questions may be generated based on the previous response(s) from the candidate. An example of the latter may be if a candidate states that a personal strength is leadership, follow-up questions directed to leadership qualities may be generated, while if the candidate states that a personal strength is problem solving, follow-up questions directed to problem solving may be generated. Dynamic testing may also include follow-up questions probing a candidate's perceived weaknesses.

The performance metrics may include a summary and or weighting of the candidate's answers, including, for example, the time taken for responses, the latency of the responses, and the accuracy and/or relevance of the responses.

At 66 real-time benchmarking is performed. At this step, performance data associated with the candidate is collected, aggregated and analyzed. Such real-time benchmarking may include a comparison of the candidate's performance to predefined or dynamic scoring parameters. The scoring parameters may include core skill metrics related to the job description, job requirements, technical knowledge, personality, and other candidate metrics. Scoring parameters may also include speed and precision scores relating to the interview process.

The workflow 60 may also include a proctor monitoring function 68 and an integrity check function 69. The proctor monitoring 68 may include methods for monitoring candidate behavior, include using computer vision for facial recognition and gaze tracking and NLP models for audio-based anomaly detection. The integrity check 69 may include processes which detect and flag suspicious activities, including multiple faces or faces not matching the candidate's uploaded documents such as a driver's license, unrecognized background noise, or other suspicious behavior.

Once the interview process is complete and the integrity of the interview process is confirmed, a performance analysis is performed at 70. A stack-ranking algorithm in which potential candidates are compared against each other rather than a particular objective standard, may be used. In such a case, weights may be applied to various scoring models with additional weights given to the priorities of the job opening which may, for example, prioritize problem solving over leadership qualities. The stack-ranking mechanism employs weighted scoring matrices and neural network-based evaluations to generate granular, multi-dimensional performance insights. Such a stack-ranking algorithm may also normalize scores across candidates, geographies and other variable factors to ensure the algorithm provides a fair comparison.

The performance analysis may also provide detailed insights into a particular candidate or a group of candidates. The detailed insights may include comparative heatmaps of the distribution and proficiency of relevant skills. The detailed insights may also provide an individual and/or group skill-gap analysis.

At 71, an integration with an employer dashboard may be provided. Aggregated results of the interview process across multiple candidates may be provided. Such results may be provided in a visual format including, for example, bar graphs for individual candidate scores and pie charts for skill breakdowns. The dashboard may be a standard or customized user interface showing the results of the process. The entire platform, including the process, algorithms and candidate data/results may be securely hosted in a cloud-based environment, including, for example, AWS. The cloud-based architecture enables scalable deployment and supports multilingual assessment pipelines via fine-tuned transformer models. Data policies compliant with laws and regulations such as GDPR and CCPA may be implemented. Data may be encrypted for storage and transport.

At 72, there may be a feedback loop in which the results of the workflow are fed back into the adaptive testing step 65. User feedback (candidate and interviewer) may be collected, analyzed and suggested changes implemented. LLM may be refined using supervised learning for flagged edge cases and reinforcement learning for adaptive improvements.

With respect to APIs 62, such integrated APIs may also provide seamless data flow into and out of process 60 with respect to human resource tools such as applicant tracking systems, certification systems, and corporate learning management systems.

The computer-based data processing system and method described above is for purposes of example only and may be implemented in any type of computer system or programming or processing environment, or in a computer program, alone or in conjunction with hardware. The present disclosure may also be implemented in software stored on a computer-readable medium and executed as a computer program on a general purpose or special purpose computer. For clarity, only those aspects of the system germane to the disclosure are described, and product details well known in the art are omitted. For the same reason, the computer hardware is not described in further detail. It should thus be understood that the disclosure is not limited to any specific computer language, program, or computer. It is further contemplated that the present disclosure may be run on a stand-alone computer system, or may be run from a server computer system that can be accessed by a plurality of client computer systems interconnected over an intranet network, or that is accessible to clients over the Internet. In addition, many embodiments of the present disclosure have application to a wide range of industries. To the extent the present application discloses a system, the method implemented by that system, as well as software stored on a computer-readable medium and executed as a computer program to perform the method on a general purpose or special purpose computer, are within the scope of the present disclosure. Further, to the extent the present application discloses a method, a system of apparatuses configured to implement the method are within the scope of the present disclosure.

It should be understood, of course, that the foregoing relates to exemplary embodiments of the disclosure and that modifications may be made without departing from the spirit and scope of the disclosure as set forth in the following claims.

In describing preferred methods, systems, or apparatuses of the subject matter of the present disclosure as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose. In addition, the use of the word “or” is generally used inclusively unless otherwise provided herein.

This written description uses examples to enable any person skilled in the art to practice the claimed subject matter, including making and using any devices or systems and performing any incorporated methods. The patentable scope of the disclosed subject matter is defined by the claims and may include other examples that occur to those skilled in the art (e.g., skipping steps, combining steps, or adding steps between exemplary methods disclosed herein). Such other examples are intended to be within the scope of the claims if they have structural elements that do not differ from the literal language of the claims, or if they include equivalent structural elements with insubstantial differences from the literal languages of the claims.

1. A talent management system comprising:
an input-output interface; and
an artificial intelligence engine having a processor coupled to the input-output interface, wherein the processor is further coupled to a memory, the memory having stored thereon executable instructions that when executed by the processor cause the processor to effectuate operations comprising:
creating a data set associated with a plurality of positions and training a large language model using the data set;
receiving a request associated with an open position from one or more candidates;
interviewing a candidate selected from the one or more candidates using an adaptive questionnaire, wherein the adaptive questionnaire dynamically adjusts a next question based on a previous response to a previous question;
evaluating a candidate based on real-time benchmarking of the candidate, wherein the real-time benchmarking compares the candidate's performance to one or more position metrics using neural network algorithms; and
stack-ranking the candidate compared to other candidates.

2. The talent management system of claim 1 wherein the interviewing step is initiated by the candidate and performed autonomously.

3. The talent management system of claim 2 wherein the adaptive questionnaire increases the difficulty of questions as the interviewing step progresses.

4. The talent management system of claim 1 wherein the adaptive questionnaire provides follow-up questions based on strengths or weaknesses of the candidate.

5. The talent management system of claim 1 wherein the real-time benchmarking comprises timing or latency of responses by the candidate.

6. The talent management system of claim 1 wherein the real-time benchmarking comprises accuracy or relevance of responses by the candidate.

7. The talent management system of claim 1 wherein the real-time benchmarking comprises comparing responses by the candidate to dynamic scoring parameters.

8. The talent management system of claim 7 wherein the dynamic scoring parameters are based on speed and precision scores relating to the interviewing step.

9. The talent management system of claim 8 wherein the real-time benchmarking comprises developing a candidate skills model which is used as inputs to compare to the dynamic scoring parameters.

10. The talent management system of claim 1 wherein the executable instructions further comprise proctoring of the candidate interview, wherein the proctoring step comprises artificial intelligence driven computer vision to authenticate the candidate through facial recognition, wherein the facial recognition is performed based on a third-party document having a photograph of the candidate.

11. The talent management system of claim 1 wherein the executable instructions further comprise proctoring of the candidate interview, wherein the proctoring step comprises using NLP models to detect anomalies associated with audible contents of the interview.

12. The talent management system of claim 1 wherein the stack-ranking step is performed by a neural networks algorithm.

13. The talent management system of claim 12 wherein the stack-ranking step is performed using weighted scoring matrices.

14. The talent management system of claim 13 wherein the stack-ranking step creates heatmaps based on relevant skills of the candidate.

15. A talent management system comprising:
a trained large language model (LLM)-based interview system having audio and video inputs and audio outputs, wherein the interview system is configured to interact with a candidate using adaptive testing, the interview system comprising;
a dynamic questionnaire system configured to adaptively test the candidate, wherein the dynamic questionnaire is configured to ask a series of questions in which one or more questions are based on answers supplied by the candidate;
a proctoring system configured to monitor the behavior of the candidate;
a real-time benchmarking system configured to compare candidate performance data collected from the interview system; and
a stack-ranking system configured to rank the candidate with respect to other candidates.

16. The talent management system of claim 15 wherein the proctoring system monitors the behavior of the candidate using computer vision for facial recognition and NLP models for audio-based anomaly detection.

17. The talent management system of claim 16 wherein facial recognition is performed based on a third-party document having a photograph of the candidate.

18. The talent management system of claim 15 wherein the follow-up questions are further based strengths or weaknesses of the candidate.

19. The talent management system of claim 15 wherein the real-time benchmarking system comprises comparing responses by the candidate to dynamic scoring parameters.

20. The talent management system of claim 19 wherein the dynamic scoring parameters are based on speed and precision scores relating to the interview system.

21. The talent management system of claim 20 wherein the real-time benchmarking comprises developing a candidate skills model which is used to compare to the dynamic scoring parameters.

22. The talent management system of claim 15 wherein the stack-ranking system using a neural networks algorithm.

23. The talent management system of claim 22 wherein the stack-ranking system further uses a weighted scoring matrix in conjunction with the neural networks algorithm.

24. The talent management system of claim 23 wherein the stack-ranking system creates heatmaps based on relevant skills of the candidate.

25. A talent management system comprising:
a trained large language model (LLM)-based interview system having audio and video inputs and audio outputs, wherein the interview system is configured to interact with a candidate using adaptive testing, the interview system comprising;
a dynamic questionnaire system configured to adaptively test the candidate, wherein the dynamic questionnaire is configured to ask a series of questions in which one or more questions are based on answers supplied by the candidate and further based on strengths and weaknesses of the candidate;
a proctoring system configured to monitor the behavior of the candidate wherein the proctoring system monitors the behavior of the candidate using computer vision for facial recognition and NLP models for audio-based anomaly detection;
a real-time benchmarking system configured to compare candidate performance data collected from the interview system, wherein the real-time benchmarking system comprises developing a candidate skills model which is used to compare to dynamic scoring parameters; and
a stack-ranking system configured to rank the candidate with respect to other candidates, wherein the stack-ranking system uses a weighted scoring matrix in conjunction with a neural networks algorithm.
